(19) United States
(12) Patent Application Publication
(10) Pub. No.: US 2026/0320321 A1
(43) Pub. Date: Oct. 15, 2026

(54) SERVER FOR PROVIDING ATTENDANCE MANAGEMENT SERVICE USING NFC TAG AND METHOD OF PROVIDING ATTENDANCE MANAGEMENT SERVICE USING THE SAME

(71) Applicant: SOFTLEAFS Co., Ltd., Seoul (KR)

(72) Inventor: Kyounghwan SUNG, Seoul (KR)

(73) Assignee: SOFTLEAFS Co., Ltd., Seoul (KR)

(21) Appl. No.: 19/644,611

(22) Filed: Apr. 10, 2026

(30) Foreign Application Priority Data
Apr. 11, 2025 (KR) 10-2025-0047180

(51) Int. Cl. G06K 7/10

(52) U.S. Cl. CPC G06K 7/10297

(57) ABSTRACT

A server for providing an attendance management service, comprising: a memory in which an attendance management program for providing the attendance management service is stored; and a processor configured to execute the attendance management program, wherein the attendance management program is configured to: receive host information including at least one of first user information, at least one management place information, management type information, and a management personnel list from a first user terminal; generate tag information for NFC tags arranged at respective management places based on the host information; receive, from a second user terminal, an NFC signal generated based on tagging between the second user terminal and the NFC tag; generate attendance information for a second user based on the NFC signal; and provide the attendance information to at least one of the first user terminal and the second user terminal.

### CROSS-REFERENCE TO RELATED APPLICATION

This application claims priority under 35 U.S.C §119 to Korean Patent Application No.10-2025-0047180 filed on Apr. 11, 2025, the entire contents of which are hereby incorporated by reference.

### TECHNICAL FIELD

The present disclosure relates to a server for providing an attendance management service and a method of providing an attendance management service using the same.

### BACKGROUND

The matters described in this section merely provide background information for the present embodiment and do not constitute prior art.

Currently, work attendance confirmation and management systems record and manage attendance information by using biometric devices such as fingerprint recognition devices, card readers using access cards, and GPS-based location identification systems.

However, each method has the following limitations. A card reader requires additional hardware installation and maintenance, and there is a possibility that fraudulent acts such as loss and proxy check-in may occur. A biometric device has a high initial installation cost and issues related to protection of sensitive personal information. In addition, a GPS-based system may have low reliability in an indoor environment due to accuracy and location limitations.

As described above, currently used work attendance management systems require separate equipment and incur costs for installation and maintenance, and particularly when workplaces are arranged at multiple locations, there is a problem in that installation and operation of the system are inefficient and complicated.

Accordingly, a technology for solving such problems is required.

### SUMMARY

An aspects of the present disclosure is to provide a server for providing an attendance management service capable of managing attendance records through near field communication (NFC) technology using a smartphone and a method of providing an attendance management service using the same.

The aspects of the present disclosure are not limited to the objects described above, and other objects and advantages of the present disclosure that are not mentioned may be understood by the following description and will be more clearly understood by embodiments of the present disclosure. In addition, it will be readily understood that the objects and advantages of the present disclosure may be realized by means and combinations thereof set forth in the claims.

According to some aspects of the present disclosure, a server for providing an attendance management service including: a memory in which an attendance management program for providing the attendance management service is stored; and a processor configured to execute the attendance management program, wherein the attendance management program is configured to: receive host information including at least one of first user information, at least one management place information, management type information, and a management personnel list from a first user terminal; generate tag information for NFC tags arranged at respective management places based on the host information; receive, from a second user terminal, an NFC signal generated based on tagging between the second user terminal and the NFC tag; generate attendance information for a second user based on the NFC signal; and provide the attendance information to at least one of the first user terminal and the second user terminal, wherein the tag information includes unique identification information of the NFC tag, management place information where the NFC tag is arranged, and the first user information, and wherein the NFC signal includes tagging time information, unique identification information of the NFC tag, and second user information.

According to some aspects, wherein the management type is one of work attendance management and attendance management, wherein the attendance management program is configured to: query the second user from host information corresponding to the first user information based on the NFC signal; and generate the attendance information for the second user based on the management type set in the host information, and wherein the attendance information includes at least one of the tagging time information, the management place information, and state information for the management type.

According to some aspects, wherein the attendance management program is configured to: receive schedule information for each management place from the first user terminal; and provide a schedule notification to the second user terminal based on the schedule information, and wherein the schedule information includes management personnel information for the management place and activity time information set for the management personnel.

According to some aspects, wherein the attendance management program is configured to: receive at least one of job information or event information for a predetermined management place through the first user terminal; and provide at least one of the job information or the event information to the second user terminal based on provision conditions, and wherein the event information includes at least one of a conference, a seminar, a performance, or a lecture.

According to some aspects, wherein the attendance management program is configured to: receive participation application information for at least one of the job information or the event information from the second user terminal; and transmit the participation application information to the first user terminal.

According to some aspects, wherein the attendance management program is configured to: recommend predetermined job information to the second user terminal based on past attendance information of the second user.

According to some aspects, wherein the attendance management program is configured to: generate work pattern data including at least one of a preferred work region, a preferred work time zone, a preferred work position, an average work time, and a work attendance evaluation of the second user based on the past attendance information of the second user; and recommend the job information to the second user terminal based on the work pattern data.

According to some aspects, wherein the attendance management program is configured to: extract n work places among work places at which the second user worked during a recent predetermined period based on the past attendance information of the second user; and recommend the job information included in a work range formed by connecting the n work places to the second user terminal.

According to some aspects, wherein the management personnel list includes salary information for each management personnel member, and wherein the attendance management program is configured to: generate salary data of the second user based on the management personnel list and the attendance information; and provide the salary data to the first user terminal.

According to some aspects of the present disclosure, a method of providing an attendance management service comprising: receiving host information including first user information, at least one management place information, management type information, and a management personnel list from a first user terminal; generating tag information for NFC tags arranged at respective management places based on the host information; receiving an NFC signal generated based on tagging between a second user terminal and the NFC tag from the second user terminal; generating attendance information for the second user based on the NFC signal; and providing the attendance information to at least one of the first user terminal and the second user terminal.

The server for providing an attendance management service and the method of providing an attendance management service using the same according to the present disclosure enable intuitive and convenient attendance management by managing attendance records by tagging an NFC tag arranged at a management place through a user terminal.

In addition, since attendance records are managed using the NFC tag arranged at the management place, costs may be minimized because the system is free from spatial and facility constraints of an attendance management place.

In addition, since an NFC tag and a user terminal such as a smartphone are used, installation costs may be reduced because a separate device is not required.

In addition, attendance data may be received and recorded in real time through a user terminal such as a smartphone and may be provided to an administrator terminal, thereby enabling intuitive information provision and confirmation.

In addition, attendance check may be performed only at a specific location where the NFC tag is installed, thereby enhancing security and reliability.

In addition, scalability and integration of data may be improved by interworking with an external system such as an administrator system connected to the administrator terminal.

In addition to the above description, specific effects of the present disclosure will be described together while describing specific matters for implementing the present disclosure below.

### BRIEF DESCRIPTION OF THE DRAWINGS

FIG. 1 is a conceptual diagram schematically illustrating a server for providing an attendance management service according to an embodiment of the present disclosure.

FIG. 2 is an exemplary diagram for explaining a tagging operation between the second user terminal illustrated and an NFC tag in FIG. 1.

FIG. 3 is a block diagram schematically illustrating a configuration of the server for providing an attendance management service according to an embodiment of the present disclosure.

FIG. 4 is an exemplary diagram for explaining a schematic operation of the server for providing an attendance management service according to an embodiment of the present disclosure.

FIG. 5 is an exemplary diagram for explaining a work attendance management operation of the server for providing an attendance management service according to an embodiment of the present disclosure.

FIG. 6 is an exemplary diagram for explaining an attendance management operation of the server for providing an attendance management service according to an embodiment of the present disclosure.

FIG. 7 is an exemplary diagram for explaining a school attendance management operation of the server for providing an attendance management service according to an embodiment of the present disclosure.

FIG. 8 is a flowchart illustrating a method of providing an attendance management service according to an embodiment of the present disclosure.

### DETAILED DESCRIPTION OF THE PREFERRED EMBODIMENTS

The terms and words used in the present specification and the claims should not be interpreted as being limited to their ordinary or dictionary meanings. According to the principle that an inventor may define the meanings of terms or words in order to best describe his or her own invention, the terms should be interpreted in meanings and concepts consistent with the technical spirit of the present disclosure. In addition, the embodiments described in the present specification and the configurations illustrated in the drawings are merely exemplary embodiments in which the present disclosure is implemented and do not represent the entirety of the technical spirit of the present disclosure, and therefore it should be understood that various equivalents, modifications, and applicable examples capable of replacing them at the time of filing may exist.

The terms such as first, second, A, and B used in the present specification and the claims may be used to describe various components, but the components should not be limited by such terms. Such terms are used only for the purpose of distinguishing one component from another. For example, without departing from the scope of the present disclosure, a first component may be referred to as a second component, and similarly, the second component may also be referred to as the first component. The term “and/or” includes a combination of a plurality of associated listed items or any one of the plurality of associated listed items.

The terms used in the present specification and the claims are merely used to describe specific embodiments and are not intended to limit the present disclosure. A singular form is intended to include a plural form unless the context clearly indicates otherwise. In the present application, terms such as “include” or “have” should be understood as not precluding the presence or addition of features, numbers, steps, operations, components, parts, or combinations thereof described in the specification.

Unless otherwise defined, all terms used herein, including technical or scientific terms, have the same meanings as those generally understood by a person of ordinary skill in the technical field to which the present disclosure pertains.

Terms that are defined in commonly used dictionaries should be interpreted as having meanings consistent with the contextual meanings in the relevant art and should not be interpreted in an idealized or overly formal sense unless expressly defined in the present application.

In addition, each configuration, process, procedure, or method included in each embodiment of the present disclosure may be shared to the extent that they are not technically inconsistent with one another.

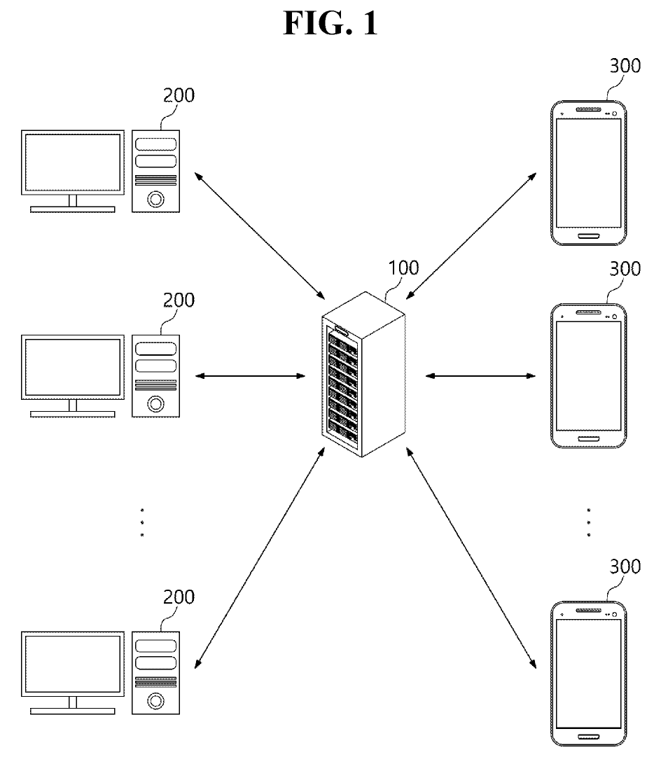

Hereinafter, with reference to FIGS. 1-8, a server for providing an attendance management service and a method of providing an attendance management service using the same according to embodiments of the present disclosure will be described in detail.

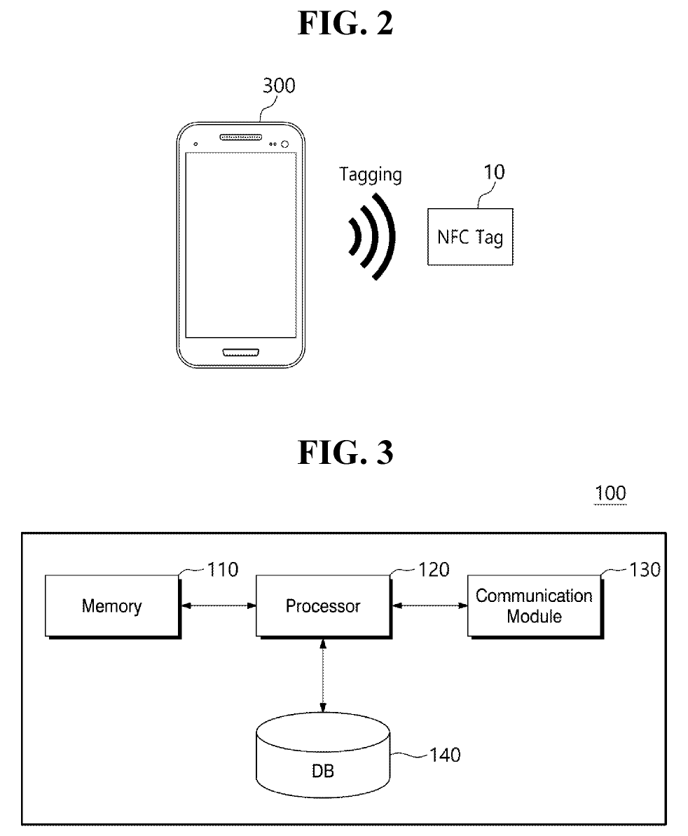

FIG. 1 is a conceptual diagram schematically illustrating a server for providing an attendance management service according to an embodiment of the present disclosure, FIG. 2 is an exemplary diagram for explaining a tagging operation between the second user terminal illustrated and an NFC tag in FIGS. 1, and 3 is a block diagram schematically illustrating a configuration of the server for providing an attendance management service according to an embodiment of the present disclosure.

The server for providing an attendance management service will be described with reference to FIGS. 1-3. A server for providing an attendance management service 100 receives host information including at least one of management place information, management type information, and a management personnel list from at least one first user terminal 200, and generates first user information and tag information for an NFC tag 10 arranged at each management place of a first user on the basis of the host information. In this case, the NFC tag 10 may be arranged at each management place.

The server for providing an attendance management service 100 receives, from the second user terminal 300, an NFC tag signal based on tagging between the second user terminal 300 and the NFC tag 10, generates attendance information for the second user based on the NFC signal, and may provide the attendance information to at least one of the first user terminal 200 and the second user terminal 300.

Here, the first user terminal 200 may be a device such as a smartphone, a tablet PC, a desktop, or a laptop, and the second user terminal 300 may be a device capable of performing NFC communication such as a tablet PC or a smartphone. In addition, tag information for the NFC tag 10 may include unique identification information of the NFC tag 10 such as a serial number, management place information where the NFC tag 10 is arranged, and first user information. In addition, the NFC signal may include tagging time information, unique identification information of the corresponding NFC tag 10, and second user information. In addition, the attendance information may include tagging time information, first user information, management place information, and attendance state information based on a management type of the first user.

That is, when the second user tags the NFC tag 10 by using the second user terminal 300, the second user terminal 300 may transmit an NFC signal to the server for providing an attendance management service 100, and the server for providing an attendance management service 100 may generate attendance information for the corresponding second user based on the NFC signal. For example, the attendance information may include information indicating that the second user has arrived at work, attended, or left work at a first management place of the first user at a first time.

Here, the first user may be a work attendance manager who manages attendance of regular employees or temporary workers, an attendance administrator who manages attendance of a school or an academy, or a manager who manages participants of events such as conferences, seminars, and performances.

As described above, the server for providing an attendance management service 100 may provide an attendance management service such as work attendance management of regular employees and temporary workers such as part-time workers of a company, attendance management of a school or an academy, and participant management of conferences, seminars, and performances.

In order to perform such operations, the server for providing an attendance management service 100 may include a memory 110 and a processor 120.

The memory 110 may store an attendance management program for providing an attendance management service. The memory 110 may be interpreted as collectively referring to a non-volatile storage device that maintains stored information even when power is not supplied and a volatile storage device that requires power to maintain stored information. In addition, the memory 110 may perform a function of temporarily or permanently storing data processed by the processor 120. The memory 110 may include a non-volatile storage device such as a magnetic storage media or a flash storage media in addition to a volatile storage device that requires power to maintain stored information, but the scope of the present disclosure is not limited thereto.

The processor 120 may execute the attendance management program stored in the memory 110 to provide an attendance management service for managing attendance of the second user who arrives at work, attends, or participates at a predetermined place.

Meanwhile, the processor 120 may perform hardware control functions required as the program is executed, such as a file system, memory allocation, a network, basic libraries, timers, device control (display, media, input devices, 3D, and the like), and other utilities. In the present embodiment, the processor 120 may be implemented in the form of a microprocessor, a central processing unit (CPU), a processor core, a multiprocessor, an application-specific integrated circuit (ASIC), or a field programmable gate array (FPGA), but the scope of the present disclosure is not limited thereto.

The communication module 130 may include a device including hardware and software required for transmitting and receiving signals such as control signals or data signals through wired or wireless connection with another network device in order to perform data communication of signal data with an external device. The database 140 may store various data for operation of the attendance management program, such as first user data, host information corresponding to the second user, and NFC tag data including tag information for the NFC tag.

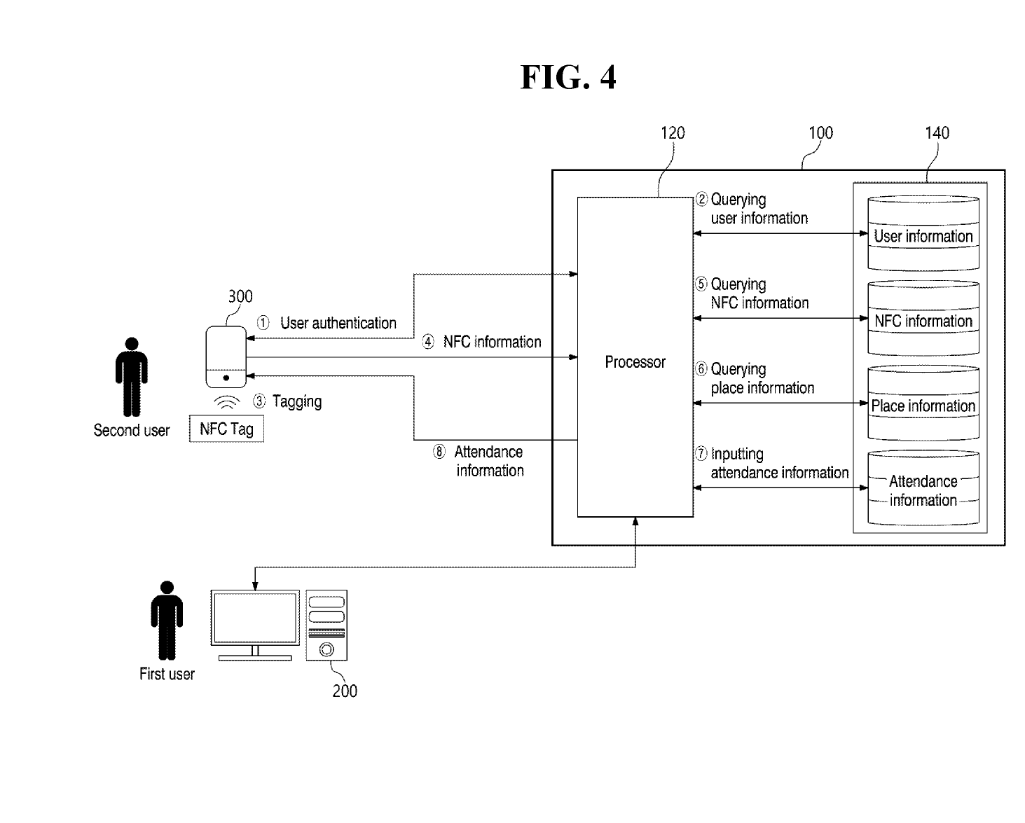

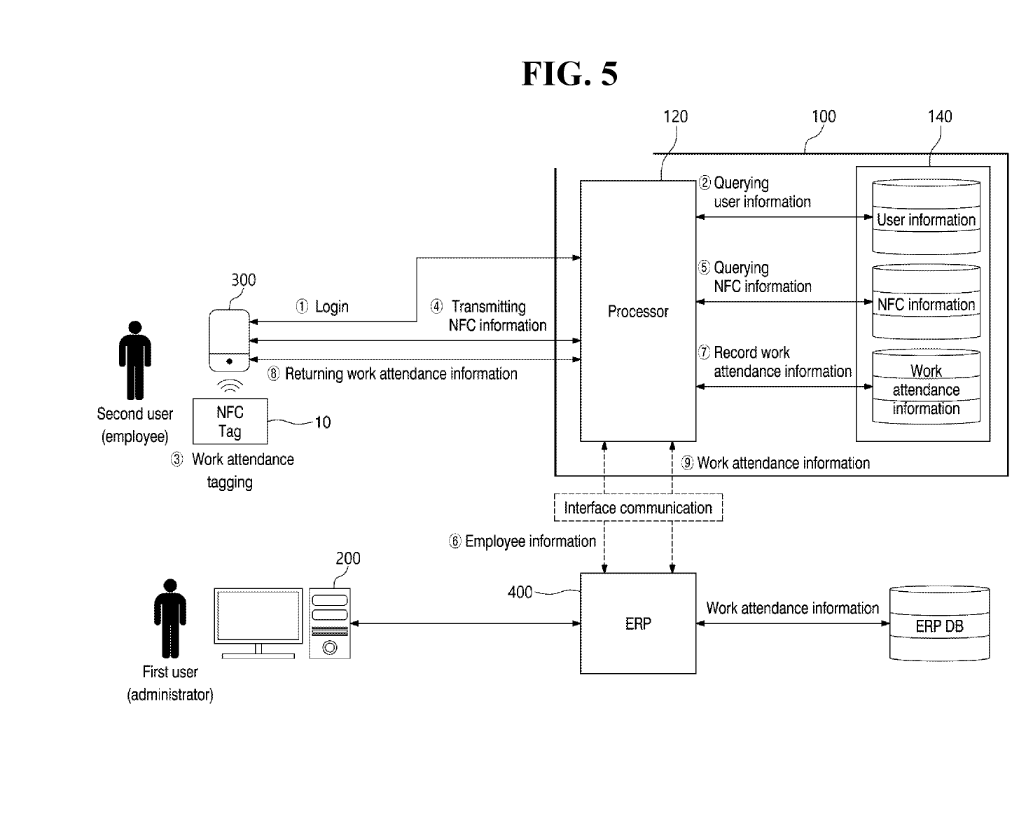

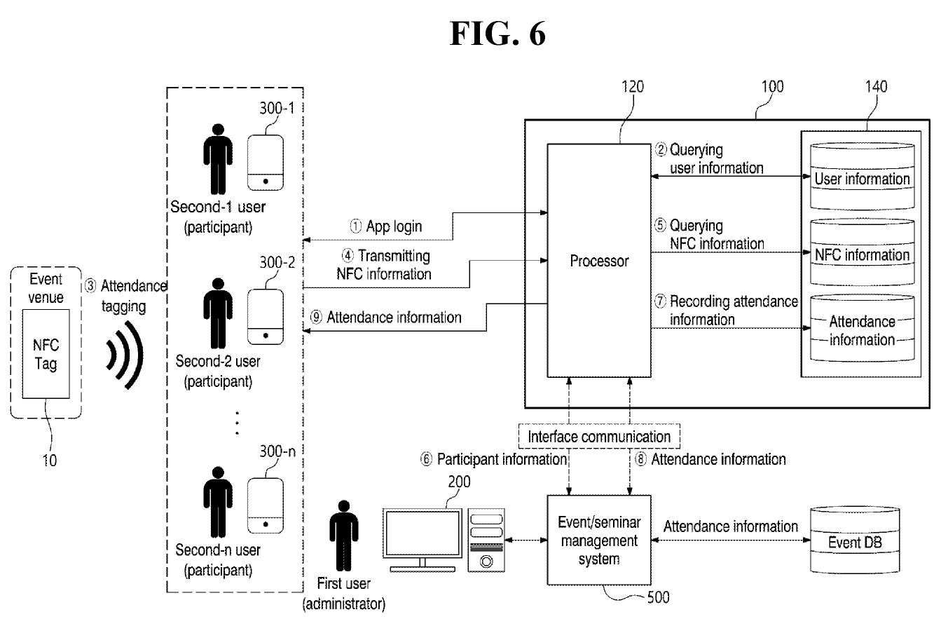

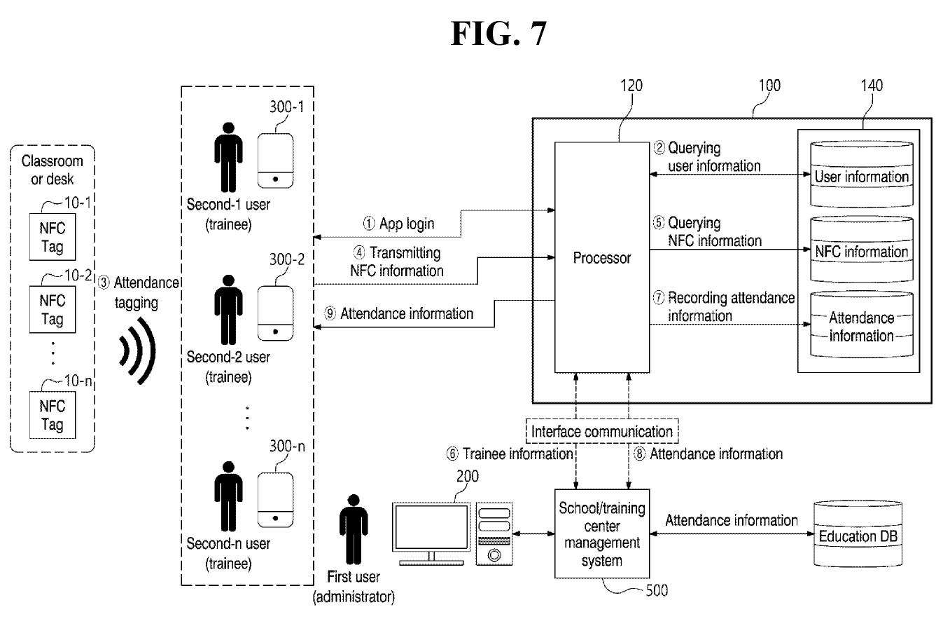

FIG. 4 is an exemplary diagram for explaining a schematic operation of the server for providing an attendance management service according to an embodiment of the present disclosure, FIG. 5 is an exemplary diagram for explaining a work attendance management operation of the server for providing an attendance management service according to an embodiment of the present disclosure, FIG. 6 is an exemplary diagram for explaining an attendance management operation of the server for providing an attendance management service according to an embodiment of the present disclosure, and FIG. 7 is an exemplary diagram for explaining a school attendance management operation of the server for providing an attendance management service according to an embodiment of the present disclosure.

Referring to FIG. 4, a schematic operation of the attendance management program will be described.

The attendance management program may perform an operation of receiving host information from the first user terminal 200 to generate tag information for the NFC tag 10 arranged at the management place of the first user and an operation of receiving an NFC signal from the second user terminal 300 to generate attendance information of the corresponding second user.

First, an operation of generating tag information for the NFC tag 10 arranged at the management place of the first user will be described. The attendance management program may receive host information including first user information, at least one management place information, management type information, and a management personnel list from the first user terminal 200, and may generate and store tag information for the NFC tag 10 arranged at each management place based on the host information.

Here, the first user information may be a name representing the first user such as a company name or a store name, the management type may be any one of work attendance management, event participation management, and school attendance management, and the tag information may include unique identification information of the NFC tag 10 such as a serial number, management place information where the NFC tag 10 is arranged, and first user information.

Next, with reference to FIG. 4, an operation of generating attendance information of the second user will be described. When the attendance management program receives a login signal from the second user terminal 300 (①), the attendance management program queries the corresponding second user information from a user information table of the database 140 (②), thereby completing login of the second user. The login operation may be performed only initially.

Thereafter, the attendance management program receives (④), from the second user terminal 300, an NFC signal generated by tagging (③) between the second user terminal 300 and the NFC tag 10. Then, the attendance management program generates attendance information of the second user based on the received NFC signal, and may provide the generated attendance information to at least one of the first user terminal 200 and the second user terminal 300. In this case, the NFC signal may include tagging time information, unique identification information of the corresponding NFC tag 10, and second user information.

Describing the operation of generating the attendance information of the second user, the attendance management program queries tag information of the NFC tag 10 from an NFC tag information table of the database 140 using the unique identification information of the NFC tag 10 included in the NFC signal (⑤), and queries a management place from a place information table of the database 140 using the unique identification information of the NFC tag 10 (⑥). Thereafter, attendance information of the second user may be generated and stored based on the tag information of the NFC tag 10 and the management place information (⑦), and the generated attendance information may be provided to the second user terminal 300 (⑧). For example, the attendance information may include information indicating that the second user has arrived at work, attended, or left work at a first management place of the first user at a first time.

In addition, when a request signal for attendance information of a predetermined second user is received from the first user terminal 200, the attendance management program may provide attendance information of the corresponding second user to the first user terminal 200. In this case, the attendance management program may provide a dashboard for the first user, and the first user may check an attendance state of the second user managed by the first user for each management place in real time.

FIG. 5 is an exemplary diagram for explaining an operation of the server for providing an attendance management service performing work attendance management. With reference to FIG. 5, a work attendance management operation of the attendance management program will be described.

When the server for providing an attendance management service 100 performs work attendance management, the first user may be a company such as an enterprise, and the second user may be a regular employee working at a fixed workplace or a temporary worker working at a non-fixed workplace such as a store or a construction site. However, the first user and the second user are not limited thereto.

In addition, the management place of the first user may be an office where the regular employee works or a site or store where the temporary worker works, and hereinafter the management place will be described as a workplace. At least one NFC tag 10 may be arranged at each workplace that is the management place of the first user.

In addition, the server for providing an attendance management service 100 may obtain information related to a management personnel list through interface communication with an ERP server 400 in which employee information of employees working at a company corresponding to the first user or personnel information managed by the company is stored.

Next, a work attendance management operation of the attendance management program will be described.

The attendance management program completes login of the second user by querying user information (②) when a login signal is received (①) from the second user terminal 300 of the second user (worker). The login process may be performed only initially and may be omitted thereafter.

Thereafter, when the second user (worker) tags the NFC tag 10 arranged at the management place of the first user, that is, a workplace (office, store, site) of the second user, by using the second user terminal 300, that is, communicates with the NFC tag 10 (③), an NFC signal is received from the second user terminal 300 (④). Then, first user information and workplace information are queried from the database 140 using unique identification information of the NFC tag 10 included in the NFC signal (⑤), and second user information is queried from the ERP server 400 corresponding to the first user information (⑥), thereby generating work attendance information of the corresponding second user (employee) (⑦). In this case, the work attendance information may include a time of arrival at work or a time of leaving work and a workplace of the first user where the NFC tag 10 is installed. For example, the work attendance information may include information such as “08:50 arrival at first office” or “19:00 leaving first office.” The time of arrival at work and the time of leaving work may be a time at which the NFC tag 10 is tagged.

In the operation of generating the work attendance information (⑦), the attendance management program may query work record data including previous work attendance information from a work attendance information table for the second user in the database 140 and record the generated work attendance information in the work record data. In this case, when there is no work record for a corresponding day in the work record data, the attendance management program may record arrival at work based on the NFC signal, and when there is a record of arrival at work on the corresponding day, the attendance management program may record leaving work based on the NFC signal.

In addition, the attendance management program may update work record data of the second user by reflecting a work type of the second user, such as annual leave or half-day leave, based on the second user information queried from the ERP server 400. In this case, the attendance management program may query all second user (worker) information from the ERP server 400 of the first user at a preset time every day and may update work record data of the corresponding second user (worker) based on the queried information. For example, the attendance management program may query second user (worker) information belonging to the first user from the ERP server 400 of the first user at 22:00 every day and may update work record data of the corresponding second user (worker).

Thereafter, the attendance management program may transmit work attendance information of the second user to the second user terminal 300 (⑧) and may transmit the work attendance information to the ERP server 400 of the first user (⑨).

In addition, the attendance management program may receive schedule information for each workplace from the first user terminal 200 and may provide arrival information to the second user terminal 300 based on the schedule information for each workplace. The schedule information may include at least one of a list of second users arriving at each workplace and work time information of each second user.

For example, when three workplaces are set for the first user, based on schedule information for each workplace, workplace information and work time information may be provided to the second user terminal 300 of the second user assigned to each workplace before a predetermined time from the work time. For example, when the work time is in the morning, workplace information and work time information may be provided on a day before the work day, and when the work time is in the afternoon, workplace information and work time information may be provided in the morning of the work day.

In addition, when the first user manages temporary workers, the attendance management program may receive job information for each workplace from the first user terminal 200 and may provide the job information to the second user terminal 300. In this case, the job information may be provided to the second user terminal 300 corresponding to a management personnel list included in host information of the first user.

More specifically, the attendance management program may generate work pattern data of the second user based on work record data of the second user. Work pattern data may include at least one of a preferred work region, a preferred work time zone, a preferred work position, an average work time, and a work attendance evaluation.

The attendance management program may recommend, to the first user terminal 200, a second user corresponding to predetermined job information, or may recommend predetermined job information to the second user terminal 300 based on work pattern data of the second user. In addition, the attendance management program may receive participation application information for job information from the second user terminal 300, and may provide the participation application information to the first user terminal 200 or the ERP server 400.

More specifically, the attendance management program may provide job information to the second user terminal 300 based on a distance condition from work record data of the second user. The attendance management program may extract n work places from among work places at which the second user worked during a recent first period from the work record data of the second user, where n is a natural number. Then, a first work range formed by connecting the n work places on a map may be derived. The work range may be formed as a circle or a polygon and may be intuitively represented on a map. However, the present embodiment is not limited thereto.

In addition, the first period may vary according to a user setting, and when the number of work places at which the second user worked during the first period is less than n, a circle connecting the work places fewer than n may be formed and set as the first work range.

Thereafter, the attendance management program may provide job information to the second user terminal 300 based on a range condition set by the second user. The range condition may be one of a minimum range, a maximum range, and a set range.

For example, when the second user sets the range condition to the minimum range, the attendance management program may recommend job information included in the narrowest first work range formed by the n work places, and when the range condition is set to the maximum range, the attendance management program may recommend job information included in the widest first work range. In addition, when the second user sets the range condition to a predetermined range value, the attendance management program may provide job information included in a first work range closest to the range value set by the second user to the second user terminal 300. In this case, when there is one first work range, job information included in the first work range may be provided.

Additionally, the attendance management program may provide job information based on the number of work places at which the second user worked during the first period and the range condition. For example, when there is one work place during the first period, a circle centered on the work place may be set as the first work range. In this case, a radius of the first work range may be based on the range condition set by the second user. Reference values may be preset for the minimum and maximum of the range condition. If a reference value of 5 km is set for the minimum, the first work range may be a circle having a radius of 5 km based on the work place serving as a center. In addition, the radius of the first work range may be set based on a distance value set by the user.

In addition, the attendance management program may provide, to the second user terminal 300, job information included in a first work range that is closest to an address of the second user among a plurality of first work ranges.

As described above, since the attendance management program provides job information based on a range condition set by the second user, job information reflecting a style of the second user with respect to travel time to a work place may be provided.

In addition, the attendance management program may recommend, to the first user terminal 200, a second user list corresponding to job information based on a first work range of the second user. For example, when first job information is included in first work ranges of ten second users, the ten second users may be recommended to the first user terminal 200. In this case, the second user information and the first work range of the corresponding second user may be provided together to the first user terminal 200 so that the first user may select the second user based on the information.

In addition, the attendance management program may extract n work places most recently worked by the second user from work record data of the second user, or may extract n work places simultaneously worked during a recent predetermined period. Then, a second work range formed by connecting the n work places on a map may be derived, and job information included in the second work range may be provided to the second user terminal 300. In addition, based on the second work range for each second user, a second user list corresponding to job information may be recommended to the first user.

Since the n work places simultaneously worked during the recent predetermined period may represent a recent activity range of the second user, job information may be provided to the second user by reflecting the recent activity range of the second user, and the second user may also be recommended to the first user.

In addition, the attendance management program may generate salary data of the second user and provide the salary data to the first user terminal 200 or the ERP server 400. The management personnel list included in the host information may include salary information for each management personnel member (a regular worker or a temporary worker), and the attendance management program may generate salary data of each second user based on the salary information included in the management personnel list and attendance information of the second user.

FIG. 6 is an example diagram for explaining an operation of the server for providing an attendance management service that performs event attendance management according to an embodiment of the present disclosure. Referring to FIG. 6, an attendance management operation of the attendance management program will be described.

When the server for providing an attendance management service 100 performs event attendance management, the first user may be an organizer who hosts an event such as a conference, seminar, performance, or lecture, and the second user may be a participant who participates in the event. In this case, a management place of the first user is a place where a conference, seminar, performance, or lecture is provided, such as a concert hall or an auditorium, and will hereinafter be referred to as an event venue. In addition, a plurality of NFC tags 10 may be provided and arranged in a plurality of areas of each event venue. For example, a first NFC tag may be arranged at a first entrance, and a second NFC tag may be arranged at a second entrance, and entrance information of each entrance may be included in tag information set in each NFC tag.

In addition, the server for providing an attendance management service 100 may perform interface communication with a management system 500 in which event information such as conferences, seminars, performances, and lectures hosted and managed by the first user is stored. In this case, the event information may include information such as an event name, an event venue, a capacity, and a price.

Next, an attendance management operation of the attendance management program will be described.

The attendance management program completes login of the second user by querying user information (②) when a login signal is received (①) from the second user terminal 300 of the second user (participant). The login process may be performed only initially and may be omitted thereafter.

Thereafter, when the second user (participant) tags (③) the NFC tag 10 arranged at an event venue of the first user using the second user terminal 300, the attendance management program receives an NFC signal (④) from the second user terminal 300. Then, by using unique identification information of the NFC tag 10 included in the NFC signal, the attendance management program may query first user information and event venue information from the database 140 (⑤), and query event schedule information for the event venue and second user information (participant) from the management system 500 of the first user (⑥), thereby generating participation information for the second user (participant) (⑦). In this case, the participation information may include participation time, a participating event program, and the event venue of the first user in which the NFC tag 10 is installed.

In the operation of generating the participation information (⑦), the attendance management program may query participation record data including previous participation information from a participation information table for the second user in the database 140 and may record the generated participation information in the participation record data. Thereafter, the attendance management program may transmit the participation information of the second user to the second user terminal 300 (⑧), and may transmit the participation information to the management system 500 of the first user (⑨).

In addition, the attendance management program may receive event information for each event venue from the first user terminal 200 or the management system 500 and may provide the event information to the second user terminal 300. For example, the event information may include information such as a date, a place, a ticket price, and a capacity.

More specifically, the attendance management program may generate participation pattern data of the second user based on participation record data of the second user. The participation pattern data may include at least one of a preferred region, a preferred time zone, a preferred event program type, an average running time of participated event programs, and an average ticket price. The attendance management program may recommend event information to the second user terminal 300 based on the participation pattern data for the second user

FIG. 7 is an example diagram for explaining an operation of the server for providing an attendance management service that performs attendance management. Referring to FIG. 7, an attendance management operation of the attendance management program will be described.

When the server for providing an attendance management service 100 performs attendance management, the first user may provide an education program such as a lecture, a course, or a class during a predetermined period, and the second user may be a participant who participates in the education program. For example, the first user may be an educational institution such as a school or an academy, and the second user may be a student or a trainee, but the present disclosure is not limited thereto. In addition, a management place of the first user may be a classroom, and NFC tags 10 may be arranged on desks or seats arranged in each management place, and the NFC tags 10 may include arrangement information indicating an arrangement position of the desks or seats. For example, a first NFC tag 10-1 and a second NFC tag 10-2 may correspond to different desks or seats, and each NFC tag 10 may include arrangement information such as A-1 or C-3 indicating a position at which the corresponding desk or seat is arranged in the management place.

In addition, the server for providing an attendance management service 100 may perform interface communication with a management system 500 in which lecture, course, and class information opened by the first user is stored.

Next, an attendance management operation of the attendance management program will be described.

The attendance management program completes login of the second user by querying user information (②) when a login signal is received (①) from the second user terminal 300 of the second user (trainee). The login process may be performed only initially and may be omitted thereafter.

Thereafter, when the second user (trainee) tags (③) the NFC tag 10 arranged on each desk or seat arranged in the classroom using the second user terminal 300, the attendance management program receives an NFC signal (④) from the second user terminal 300. Then, by using unique identification information of the NFC tag 10 included in the NFC signal, the attendance management program queries first user information and management place information from the database 140 (⑤), and queries schedule information for the classroom and second user information (trainee) from the management system 500 of the first user (⑥), thereby generating attendance information for the second user (trainee) (⑦). In this case, the attendance information may include an attendance time, an opened course, classroom information, and arrangement information of the desk or seat in which the NFC tag 10 is installed. That is, the attendance information may include information such as “15:50 first classroom, first course, desk A-3 attendance.”

In the operation of generating the attendance information (⑦), the attendance management program may query attendance record data including previous attendance information from an attendance information table for the second user in the database 140, and may record the generated attendance information in the attendance record data. Thereafter, the attendance management program may transmit the attendance information of the second user to the second user terminal 300 (⑧), and may transmit the attendance information to the management system 500 of the first user (⑨).

In addition, the attendance management program may receive course information opened in each classroom from the first user terminal 200 or the management system 500, and may provide the course information to the second user terminal 300. In this case, the course information may include information such as an opened subject, a lecture day, time, and professor or instructor information.

More specifically, the attendance management program may generate attendance pattern data of the second user based on attendance record data of the second user. The attendance pattern data may include at least one of preferred time zones by day of the week and preferred subject types. The attendance management program may recommend course information to the second user terminal 300 based on the attendance pattern data of the second user.

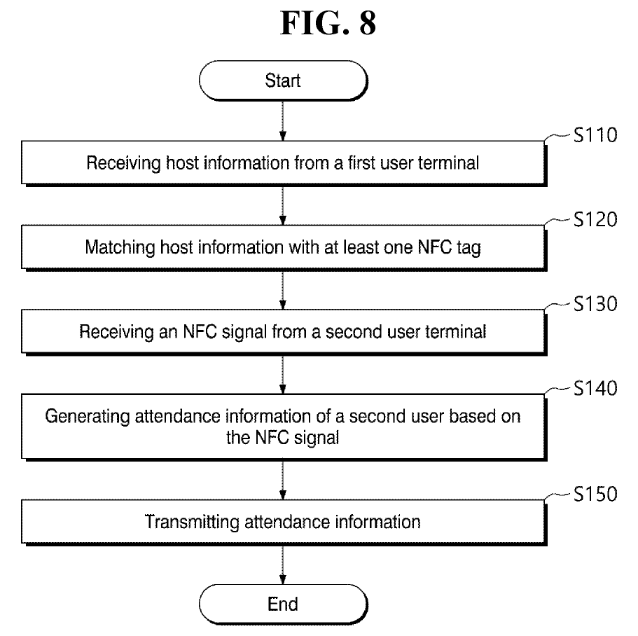

FIG. 8 is a flowchart illustrating a method of providing an attendance management service according to an embodiment of the present disclosure.

Referring to FIGS. 4 and 8, a method of providing an attendance management service using the server for providing an attendance management service 100 will be described. The method of providing an attendance management service may include a process of generating tag information for NFC tags 10 arranged at management places of the first user by receiving host information from the first user terminal 200, and a process of generating attendance information of the second user by receiving an NFC signal from the second user terminal 300.

First, a process in which the server for providing an attendance management service 100 generates tag information for NFC tags 10 arranged at management places of the first user will be described. The server for providing an attendance management service 100 receives host information from the first user terminal 200 (S110), and generates tag information for NFC tags 10 arranged at each management place of the first user based on the host information (S120).

In this case, the host information may include at least one of first user information, at least one management place information, management type information, and a management personnel list. The first user information may be a name such as a company name, a school name, or an academy name, the management type may be one of work attendance management, attendance management, and participation management, and the tag information may include unique identification information of the NFC tag 10 such as a serial number, management place information where the NFC tag 10 is arranged, and the first user information.

Next, a process in which the server for providing an attendance management service 100 generates attendance information of the second user will be described. When the server for providing an attendance management service 100 receives a login signal from the second user terminal 300 (①), the server for providing an attendance management servicer 100 queries the corresponding second user information from a user information table of the database 140 (②), thereby completing login of the second user.

Thereafter, the server for providing an attendance management service 100 receives an NFC signal (④) generated by tagging (③) between the second user terminal 300 and the NFC tag 10 from the second user terminal 300 (S130), generates attendance information of the second user based on the received NFC signal (S140), and may provide the generated attendance information to at least one of the first user terminal 200 and the second user terminal 300 (S150). In this case, the NFC signal may include tagging time information, unique identification information of the corresponding NFC tag 10, and second user information.

A process of generating attendance information of the second user (S140) will be described. The server for providing an attendance management service 100 queries tag information of the NFC tag 10 from an NFC tag information table of the database 140 by using the unique identification information included in the NFC signal (⑤), and searches for a management place in a place information table of the database 140 by using the unique identification information included in the NFC signal (⑥).

Thereafter, the attendance management service providing server 100 may generate and store attendance information of the second user based on the tag information of the NFC tag 10 and the management place information (⑦), and may provide the generated attendance information to the second user terminal 300 (⑧). For example, the attendance information may include information indicating that the second user has arrived at work, attended, or left work at a first management place of the first user at a first time.

In this case, when a request signal for attendance information of a predetermined second user is received from the first user terminal 200, the server for providing an attendance management service 100 may provide attendance information of the corresponding second user to the first user terminal 200.

The above description is merely an example of the technical idea of the present embodiment, and those with ordinary knowledge in the technical field to which the present embodiment belongs will be able to make various modifications and variations without departing from the essential characteristics of the present embodiment. Accordingly, these embodiments are not intended to limit the technical idea of the present embodiment but rather to explain it, and the scope of the technical idea of the present embodiment is not limited by these embodiments. The scope of protection of this embodiment should be interpreted by the claims below, and all technical ideas within the equivalent scope should be interpreted as being included in the scope of rights of this embodiment.

What is claimed is:

1. A server for providing an attendance management service, comprising:
a memory in which an attendance management program for providing the attendance management service is stored; and
a processor configured to execute the attendance management program,
wherein the attendance management program is configured to:
receive host information including at least one of first user information, at least one management place information, management type information, and a management personnel list from a first user terminal; generate tag information for NFC tags arranged at respective management places based on the host information; receive, from a second user terminal, an NFC signal generated based on tagging between the second user terminal and the NFC tag; generate attendance information for a second user based on the NFC signal; and provide the attendance information to at least one of the first user terminal and the second user terminal,
wherein the tag information includes unique identification information of the NFC tag, management place information where the NFC tag is arranged, and the first user information, and
wherein the NFC signal includes tagging time information, unique identification information of the NFC tag, and second user information.

2. The server for providing the attendance management service according to claim 1,
wherein the management type is one of work attendance management and attendance management,
wherein the attendance management program is configured to:
query the second user from host information corresponding to the first user information based on the NFC signal; and generate the attendance information for the second user based on the management type set in the host information, and
wherein the attendance information includes at least one of the tagging time information, the management place information, and state information for the management type.

3. The server for providing the attendance management service according to claim 2,
wherein the attendance management program is configured to:
receive schedule information for each management place from the first user terminal; and provide a schedule notification to the second user terminal based on the schedule information, and
wherein the schedule information includes management personnel information for the management place and activity time information set for the management personnel.

4. The server for providing the attendance management service according to claim 1,
wherein the attendance management program is configured to:
receive at least one of job information or event information for a predetermined management place through the first user terminal; and
provide at least one of the job information or the event information to the second user terminal based on provision conditions, and
wherein the event information includes at least one of a conference, a seminar, a performance, or a lecture.

5. The server for providing the attendance management service according to claim 4,
wherein the attendance management program is configured to:
receive participation application information for at least one of the job information or the event information from the second user terminal; and
transmit the participation application information to the first user terminal.

6. The server for providing the attendance management service according to claim 4,
wherein the attendance management program is configured to:
recommend predetermined job information to the second user terminal based on past attendance information of the second user.

7. The server for providing the attendance management service according to claim 6,
wherein the attendance management program is configured to:
generate work pattern data including at least one of a preferred work region, a preferred work time zone, a preferred work position, an average work time, and a work attendance evaluation of the second user based on the past attendance information of the second user; and recommend the job information to the second user terminal based on the work pattern data.

8. The server for providing the attendance management service according to claim 6,
wherein the attendance management program is configured to:
extract n work places among work places at which the second user worked during a recent predetermined period based on the past attendance information of the second user; and recommend the job information included in a work range formed by connecting the n work places to the second user terminal.

9. The server for providing the attendance management service according to claim 1,
wherein the management personnel list includes salary information for each management personnel member, and
wherein the attendance management program is configured to:
generate salary data of the second user based on the management personnel list and the attendance information; and provide the salary data to the first user terminal.

10. A method of providing an attendance management service using a server for providing the attendance management service, comprising:
receiving host information including first user information, at least one management place information, management type information, and a management personnel list from a first user terminal;
generating tag information for NFC tags arranged at respective management places based on the host information;
receiving an NFC signal generated based on tagging between a second user terminal and the NFC tag from the second user terminal;
generating attendance information for the second user based on the NFC signal; and
providing the attendance information to at least one of the first user terminal and the second user terminal.
